(19) United States
(12) Patent Application Publication
(10) Pub. No.: US 2026/0314609 A1
(43) Pub. Date: Oct. 15, 2026

(54) KIT-OF-PARTS CONFIGURED TO EVISCERATE, AND METHOD OF EVISCERATING A QUADRUPED SLAUGHTER ANIMAL, AS WELL AS ROBOT COMPRISING SUCH A KIT-OF-PARTS

(71) Applicant: MAREL RED MEAT B.V., LICHTENVOORDE (NL)

(72) Inventors: Arno Hermanus Maria UEFFING, LICHTENVOORDE (NL); Maarten Christiaan HUININK, LICHTENVOORDE (NL); Tom EVERS, LICHTENVOORDE (NL)

(21) Appl. No.: 19/485,929

(22) PCT Filed: Jun. 5, 2024
(86) PCT No.: PCT/NL2024/050289

§ 371 Date: Nov. 19, 2025

(30) Foreign Application Priority Data
Jun. 13, 2023 (NL) 2035077

(51) Int. Cl. A22B 5/00

(52) U.S. Cl. CPC A22B 5/0005

(57) ABSTRACT

Kit-of-parts configured to eviscerate a quadruped slaughter animal, includes: a thick skirt cutting tool, having two arms that are moveable relative to each other between a piercing entry state and a thick skirt cutting state, wherein at least one arm, and preferably each arm, includes: a thick skirt cutting blade arranged at an inner side of said arm to thereby allow the two arms to enclose an acute angle in the thick skirt cutting state and cut a thick skirt of the slaughter animal; and a diaphragm cutting tool, including two legs that each have a diaphragm cutting blade arranged near an end of said leg and configured to cut the diaphragm along at least a part of the inner contour of the breast cavity. A method is for eviscerating a quadruped slaughter animal.

### TECHNICAL FIELD

The present invention relates to a kit-of-parts configured to eviscerate a quadruped slaughter animal, in particular a pig, as well as to a robot comprising such a kit-of-parts. Moreover, the invention is further related to a method of eviscerating a quadruped slaughter animal, in particular a pig.

### BACKGROUND

Evisceration of quadruped slaughter animal, such as a pigs, involves heavy manual labour that is performed by skilled personnel of a slaughterhouse. For example, about eight skilled employees may be involved in the successive steps of eviscerating a slaughter animal. An important part of the training and skill set of the employees is aimed at preventing defilement, i.e. when carcass contamination occurs during the evisceration process. When a carcass is contaminated, it will need to be cleaned up before it can continue to the next section of the slaughter process. Cleaning up is performed by having an employee cut away contaminated parts so that the remaining part of the carcass consists entirely of clean meat that is free from the contamination.

Carcass defilement can occur by direct contact between the carcass and gastro-intestinal contents or indirectly through soiled slaughtering equipment and staff. An important cause for defilement is the intentional or accidental cutting of any of the gastro-intestinal organs. A worker can, for instance, accidentally damage the small intestine causing faeces to spill onto the carcass. Also, if the gastro-internal organs are not harvested intact but in parts, cuts will need to be made to separate the gastro-intestinal organs. Any one of these cuts, on both sides, can cause the contents of the gastro-intestinal tract to spill onto the carcass causing defilement. In particular, when the so-called white organs from the abdominal cavity and the so-called red organs from the chest cavity are harvested separately, the bile duct will need to be severed. This causes a significant risk for bile to spill thus causing defilement which will need to be cleaned up resulting in additional work and lowering yield. Also, carcasses may be contaminated by Salmonella throughout the slaughtering process by direct or cross-contamination because this pathogen may be present in the gastrointestinal tract or on the skin surface.

Besides the difficulty in finding suitable personnel willing to perform this heavy and skilled work, and training them appropriately, even the most experienced and well-trained personnel will sometimes accidentally make an inaccurate cut that results in carcass contamination.

Although attempts have been made to automate parts of the evisceration process, this has proved to be a very challenging task due to the complexity of, and variety between, quadrupled slaughter animals. There is however an ongoing desire to further automate the process of evisceration, as it reduces the personnel requirement, which can result in considerable cost savings, especially in a slaughter line. Another important advantage is that the heavy physical work can be performed by mechanically driven tools, that can realize a more constant quality of processed carcasses, with less risk of contamination of valuable meat. Also, the cyclic cleaning which is mandatory in many slaughterhouses will be more reliable. Due to the repetitive nature, workers may ease on cyclic cleaning actions or perhaps skip cleaning cycles entirely. An automated solution will always clean according to the settings ensuring optimized hygienic conditions. In additions, the number of process steps in the slaughter line may be reduced if automated solutions are used.

European patent application EP 0 397 703 is considered the closest prior art for the present invention. A tool is lowered into the carcass abdominal cavity, and once this tool reaches a given position, cutting elements of said tool rotate around an axis. An additional tool pushes the viscera after the diaphragm has been cut. It discloses:
a thick skirt cutting tool, comprising two arms that are moveable relative to each other between a piercing entry state thereof and a thick skirt cutting state, wherein at least one arm, and preferably each arm, comprises:
a thick skirt cutting blade arranged at an inner side of said arm that faces the other arm to thereby allow the two arms to enclose an acute angle in the thick skirt cutting state and cut a thick skirt of the slaughter animal; and
a diaphragm cutting tool, comprising two legs that each comprise a diaphragm cutting blade arranged near an end of said leg and configured to cut the diaphragm along at least a part of an inner contour of the breast cavity.

An objective of the present invention is to provide a kit-of-parts and method of eviscerating a quadruped slaughter animal, that is improved relative to the prior art and wherein at least one of the above stated problems is obviated or alleviated.

### SUMMARY

Said objective is achieved with the kit-of-parts according to the present invention, that is configured to eviscerate a quadruped slaughter animal, in particular a pig, comprising:
a thick skirt cutting tool, comprising two arms that are moveable relative to each other between a piercing entry state thereof and a thick skirt cutting state, wherein at least one arm, and preferably each arm, comprises:
a thick skirt cutting blade arranged at an inner side of said arm that faces the other arm to thereby allow the two arms to enclose an acute angle in the thick skirt cutting state and cut a thick skirt of the slaughter animal when the thick skirt cutting tool is moved away from a head portion towards a rear end portion of the slaughter animal; and
a diaphragm cutting tool, comprising two legs that each comprise a diaphragm cutting blade arranged near an end of said leg and configured to cut the diaphragm along at least a part of an inner contour of the breast cavity.

It is hereby understood that the diaphragm refers to the thoracic diaphragm that extends across the bottom of the chest cavity. The cavity below the diaphragm is referred to as the abdominal cavity. As a result, it is understood that the inner contour of the breast cavity that is followed by the diaphragm cutting tool corresponds with the inner contour of the breast or abdominal cavity at the height of the diaphragm.

The kit-of-parts according to the invention is capable of piercing the diaphragm, and then successively removing the thick skirt with the thick skirt cutting tool during a rear end portion directed, i.e. tail directed, movement, and cutting the diaphragm with the diaphragm cutting tool during a head portion directed (and outward) movement. In this way, a physically heavy task that is normally performed by multiple professionals can be automated, saving in personnel and resulting in a more constant quality of processed carcasses, with less risk of contamination of valuable meat. Such an automated operation is typically also more hygienic as cyclic cleaning will be more rigorous compared to the case of a manual operation. Also, the number of processing steps in the slaughter line is reduced. When the slaughter animal is suspended upside down, i.e. suspended at the rear end portion thereof, with the head portion directed downwards, the thick skirt is cut with the thick skirt cutting tool during an upward movement, and the diaphragm is cut with the diaphragm cutting tool during a downward (and outward) directed movement.

The kit-of-parts according to the invention defines an assembly of a thick skirt cutting tool and a diaphragm cutting tool, each of which may be applied independent of the other, and protected as such. Nevertheless, especially when they are applied in combination, the assembly thereof provides additional advantageous synergistic effects.

The arms of the thick skirt cutting tool being movable relative to each other encompasses both the situation wherein both legs are moveable relative to a common reference, and the situation wherein one of the legs is fixed relative to a common reference, whereas the other is movable relative to this common reference.

Although it is conceivable that only one arm of thick skirt cutting tool comprises a thick skirt cutting blade, preferably each arm of the thick skirt cutting tool comprises a thick skirt cutting blade. In this situation, the two thick skirt cutting blades enclose an acute angle in the thick skirt cutting state.

The predetermined contour may be any inner contour of the breast and/or abdominal cavity. The predetermined contour may be fully within the outer contour of the diaphragm, i.e. resulting in a cut that is only in the diaphragm. Alternatively, the predetermined contour may be wider and may also cut through the diaphragm muscle (aka outside skirt). Thus, additionally to cutting the diaphragm, the diaphragm cutting tool may also cut through the outside skirt, or through meat near or surrounding the diaphragm.

The invention at least differs relative to the disclosure of European patent application EP 0 397 703, because the thick skirt of the slaughter animal is cut when the thick skirt cutting tool is moved away from a head portion towards a rear end portion of the slaughter animal. In this way, a clean automated solution is provided for eviscerating a quadruped slaughter animal ensuring optimized hygienic conditions. Moreover, the number of process steps in the slaughter line may be reduced. Cutting the thick skirt when the thick skirt cutting tool is moved away from the head portion towards the rear end portion of the slaughter animal facilitates the extraction of the visceral package.

According to a preferred embodiment, the two legs of the diaphragm cutting tool are movable relative to each other between an entry state thereof, wherein the legs are a first offset apart, and a diaphragm cutting state, wherein the legs are spread apart further relative to the entry state to thereby allow the legs to follow a predetermined contour. It is noted here that the legs being movable relative to each other encompasses both the situation wherein both legs are moveable relative to a common reference, and the situation wherein one of the legs is fixed relative to a common reference, whereas the other is movable relative to this common reference.

According to a preferred embodiment of the kit-of-parts, at least one of the thick skirt cutting tool and the diaphragm cutting tool comprises a diaphragm piercer that is configured to pierce the diaphragm of the slaughter animal when said diaphragm piercer is moved from a rear end portion towards a head portion of the slaughter animal.

According to a further preferred embodiment of the kit-of-parts, the diaphragm piercer is arranged at an end of an arm of the thick skirt cutting tool, and the entry state of the thick skirt cutting tool defines a diaphragm piercing state thereof. If needed, both arms of the thick skirt cutting tool can be arranged with a diaphragm piercer at the end of each arm. A benefit of arranging the diaphragm piercer or piercers at the end of the arms of the thick skirt cutting tool, extending therefrom, is that after piercing the diaphragm, the thick skirt cutting tool is moved in the opposite direction causing the piercers to be at the trailing end of said tool and thereby reducing the risk that said piercers, which are being dragged, damage the meat, organs etc inside the carcass.

According to an even further preferred embodiment of the kit-of-parts, in the entry state of the thick skirt cutting tool, the two arms position the diaphragm piercers at a first distance in the range of 25-150 mm, preferably in the range of 50-100 mm, and more preferably in the range of 60-80 mm, to thereby position the diaphragm piercers on opposite sides relative to a sagittal plane of the slaughter animal.

According to an even further preferred embodiment of the kit-of-parts, in the thick skirt cutting state of the thick skirt cutting tool, the arms are substantially closed to thereby define a V-shape by the thick skirt cutting blades of the two arms. Preferably, the arms are fully closed, i.e. both arms are in abutting contact with each other. However, alternatively, the arms may be arranged at a second distance, that is smaller than the first distance, relative to each other, to thereby define a V-shape by the thick skirt cutting blades of the two arms. If the arms are closed, this second distance reaches a value of 0 mm.

According to an even further preferred embodiment of the kit-of-parts, in the entry state of the diaphragm cutting tool, the first offset is in the range of 25-150 mm, preferably in the range of 50-100 mm, and more preferably in the range of 60-80 mm.

According to an even further preferred embodiment of the kit-of-parts, it further comprises one or more than one cover configured to selectively cover one or more than one of:
the diaphragm piercers of the thick skirt cutting tool;
the thick skirt cutting blades of the thick skirt cutting tool, and
the diaphragm cutting blades of the diaphragm cutting tool.
   It is understood that these covers serve to prevent the piercers and cutting blade from engaging with all parts of the carcass when this is not required. Most noticeably, the covers function to protect the stomach and intestines when the kit-of-parts is transferred from outside the carcass towards the diaphragm where it can start the evisceration process. The covers have a blunt upper part. By using such a blunt part, the covers will not cut any organs but instead gently push said organs away from the tools.

According to an even further preferred embodiment of the kit-of-parts, the one or more than one cover is pivotable between a shielding state and an exposing state, wherein:
in the shielding state, the one or more than one cover shields at least one of the diaphragm piercers of the thick skirt cutting tool, the thick skirt cutting blades of the thick skirt cutting tool, and the diaphragm cutting blades of the diaphragm cutting tool off to protect the intestines and/or other parts of the digestive system in an abdominal cavity of the slaughter animal; and
in the exposing state, the cover is pivoted away from the diaphragm piercers of the thick skirt cutting tool and the diaphragm cutting blades of the diaphragm cutting tool to thereby expose them for piercing and cutting.

According to an even further preferred embodiment of the kit-of-parts, said one or more than one cover comprises at least two covers, wherein each cover is arranged at:
one of both arms of the thick skirt cutting tool; and/or
one of both legs of the diaphragm cutting tool.

According to an even further preferred embodiment of the kit-of-parts, said one or more than one cover comprises an outer shape that is configured to automatically urge the cover from the shielding state to the exposing state when said cover abuts and slides against the diaphragm of the slaughter animal.

According to an even further preferred embodiment of the kit-of-parts, it further comprises an actuator configured to actively pivot the one or more than one cover between the shielding state and the exposing state.

According to an even further preferred embodiment of the kit-of-parts, the actuator is an actuatable cylinder.

According to an even further preferred embodiment of the kit-of-parts, an outer side of each arm of the thick skirt cutting tool defines a guide surface configured to guide the pierced diaphragm towards the diaphragm cutting blades of the diaphragm cutting tool.

According to an even further preferred embodiment of the kit-of-parts, it comprises a drive configured to drive the arms of the thick skirt cutting tool. The drive configured to drive the arms of the thick skirt cutting tool may be a positioned controlled drive.

According to an even further preferred embodiment of the kit-of-parts, the drive is a rotational drive that drives an eccentric drive mechanism that converts the rotational action of the drive into a reciprocating action of the arms of the thick skirt cutting tool, wherein a force exerted at the ends of the arms of the thick skirt cutting tool increases when said ends approach each other. In this way, the drive mechanism provides a force optimalization for cutting the thick skirt of the slaughter animal with the thick skirt cutting blades 8, while a simple and reliable rotational drive may be used. A particular benefit of this force optimalization is that the risk of the thick skirt slipping past the thick skirt cutting blade(s) without being entirely cut is minimized. More preferably, the force exerted at the ends of the thick skirt cutting tool reaches a maximum when a spread distance between said ends reaches a minimum.

According to an even further preferred embodiment of the kit-of-parts, each leg of the diaphragm cutting tool further comprises a guide configured to guide the lungs of the slaughter animal. The diaphragm piercer comprises a pointed cutting blade extending in a longitudinal direction of said arm outward relative to the end of said arm.

According to an even further preferred embodiment of the kit-of-parts, it comprises a further drive that is configured to drive the legs of the diaphragm cutting tool. The further drive that is preferably configured to drive the legs of the diaphragm cutting tool may be a piston with rod in a cylinder, such as a pneumatic or hydraulic cylinder. Preferably the further drive is a double acting cylinder, such as a double acting pneumatic or hydraulic cylinder. It is hereby understood that a double acting cylinder is used in its normal meaning as a piston with rod in a cylinder system that can be actively controlled to move the rod to extend outside the cylinder or to retract the rod inside the cylinder. Alternatively, the further drive may be a servo motor, and/or comprise a resilient member.

According to an even further preferred embodiment of the kit-of-parts, it further comprises a base, wherein the thick skirt cutting tool and the diaphragm cutting tool are moveably arrangeable relative to said base and relative to each other.

According to an even further preferred embodiment of the kit-of-parts, the arms of the thick skirt cutting tool and the legs of the diaphragm cutting tool are moveable in parallel or coinciding planes.

According to an even further preferred embodiment of the kit-of-parts, the thick skirt cutting blades of the thick skirt cutting tool extend substantially transverse to the diaphragm cutting blades of the diaphragm cutting tool.

The invention further relates to a robot, comprising an articulated arm with a robot head carrying the base with an assembly of the thick skirt cutting tool and the diaphragm cutting tool.

The invention further relates to a method of eviscerating a quadruped slaughter animal, in particular a pig, said method comprising the steps of:
simultaneously moving a thick skirt cutting tool and a diaphragm cutting tool from a rear end portion towards a head portion of the slaughter animal;
piercing a diaphragm of the slaughter animal;
moving the thick skirt cutting tool backwards towards the rear end portion and thereby cutting the thick skirt of the slaughter animal; and
moving the diaphragm cutting tool further towards the head portion of the slaughter animal and thereby cutting the diaphragm along an inner contour of a breast cavity of the slaughter animal.

According to a preferred embodiment of the method, the step of piercing the diaphragm of the slaughter animal is performed by a diaphragm piercer of the thick skirt cutting tool.

According to a further preferred embodiment of the method, during said step of piercing the diaphragm of the slaughter animal, the diaphragm piercer of the thick skirt cutting tool extends beyond an end of the diaphragm cutting tool.

According to an even further preferred embodiment of the method, the thick skirt cutting tool comprises two arms that are movable relative to each other, wherein:
said arms are spaced apart during the step of moving the thick skirt cutting tool from the rear end portion towards the head portion of the slaughter animal; and
said arms are substantially closed, thereby defining a V-shape with thick skirt cutting blades that are arranged at the two arms, during the step of moving the thick skirt cutting tool backwards towards the rear end portion and thereby cutting the thick skirt of the slaughter animal.

Because the kit-of-parts according to the invention is capable of piercing the diaphragm, and then successively removing the thick skirt with the thick skirt cutting tool during a rear end portion directed movement, and cutting the diaphragm with the diaphragm cutting tool during a head portion directed (and outward) movement, the method is capable of performing the step of simultaneously removing so-called white and red organs from the slaughter animal. More in particular, white and red organs may be removed as a package, i.e. while they are still connected to each other.

According to an even further preferred embodiment of the method, it further comprises the step of using at least one of a thick skirt cutting tool and a diaphragm cutting tool according to the kit-of-parts of the invention.

The various aspects and features described and shown in the specification can be applied, individually, wherever possible. These individual aspects, and in particular the thick skirt cutting tool and the diaphragm cutting tool, as well as aspects and features described in the attached dependent claims, such as the drive mechanism of the thick skirt cutting tool, may be an invention in its own right that is related to a different problem relative to the prior art.

### BRIEF DESCRIPTION OF DRAWINGS

In the following description preferred embodiments of the present invention are further elucidated with reference to the drawing, in which:

FIG. 1 is a perspective view of a kit-of-parts configured to eviscerate a quadruped slaughter animal, in particular a pig, comprising a thick skirt cutting tool and a diaphragm cutting tool;

FIG. 2 is a perspective view of the thick skirt cutting tool of FIG. 1;

FIG. 3 is a perspective view of the diaphragm cutting tool of FIG. 1;

FIGS. 4-10 show frontal and side views of successive steps of a method of eviscerating a quadruped slaughter animal, in particular a pig;

FIG. 11 shows the frontal view of the kit-of-parts conform FIG. 4;

FIG. 12 shows the frontal view of the kit-of-parts conform FIG. 8;

FIG. 13 shows a robot carrying the kit-of-parts of FIG. 1;

FIG. 14 is a perspective view of the diaphragm cutting tool showing the mechanism for driving the covers;

FIG. 15 is a perspective view of the thick skirt cutting tool and a drive mechanism configured to drive the arms thereof;

FIG. 16 is a diagram showing a force at the ends of the arms of the thick skirt cutting tool versus an associated angle of the drive; and

FIG. 17 is a diagram showing a spread distance of the ends of the arms of the thick skirt cutting tool versus an associated angle of the drive.

### DETAILED DESCRIPTION

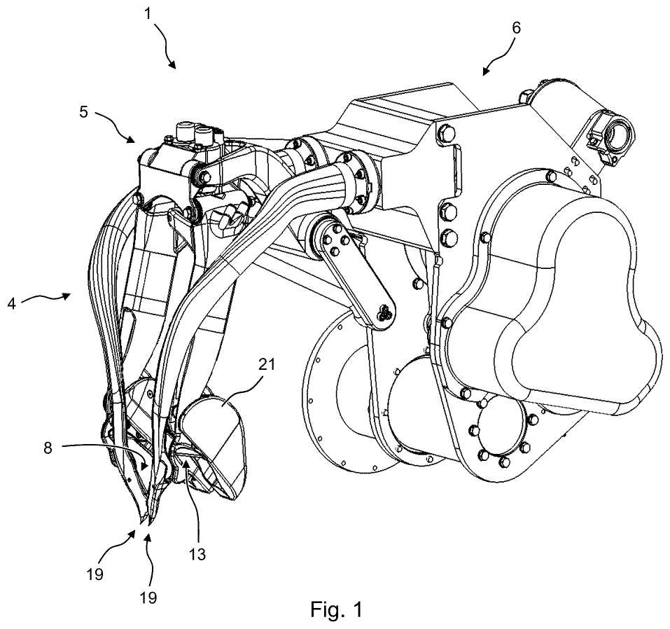

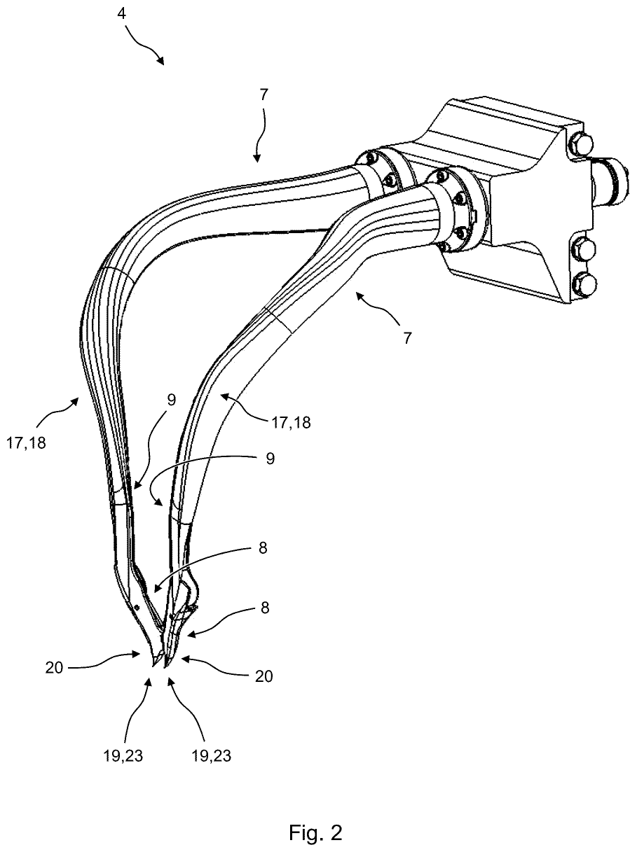

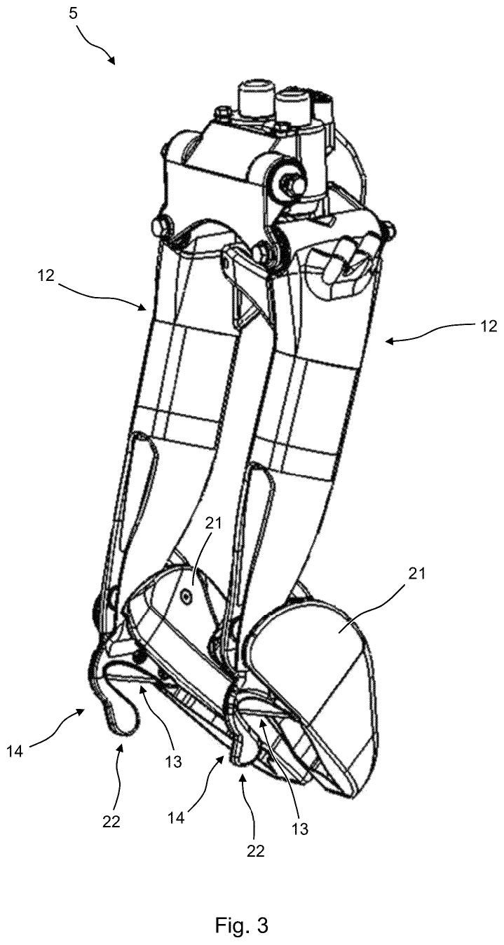

A preferred embodiment of the kit-of-parts 1 that is configured to eviscerate a quadruped slaughter animal 2, in particular a pig 3, is now described in more detail in relation to the Figures. A perspective view of the kit-of-parts 1, that comprises a thick skirt cutting tool 4 and a diaphragm cutting tool 5, is shown in FIG. 1. Detailed perspective views of the thick skirt cutting tool 4 and the diaphragm cutting tool 5, are shown in FIGS. 2 and 3, respectively. It is noted here that FIGS. 2 and 3 have a different scale, to allow the diaphragm cutting tool 5 of FIG. 3 to be shown in greater detail.

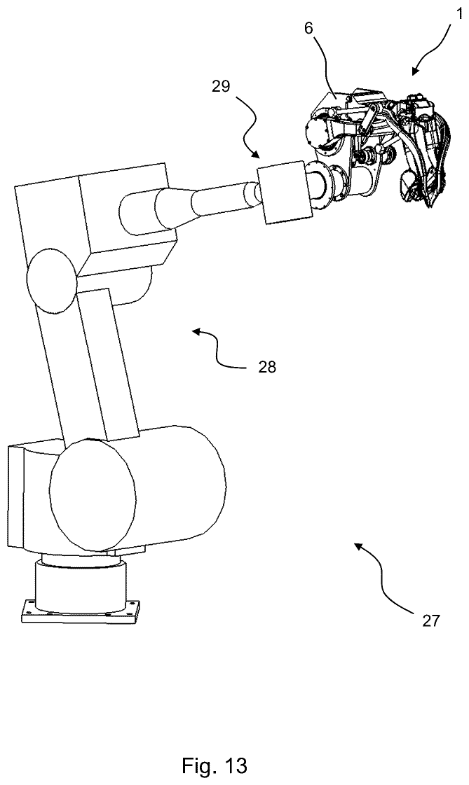

In FIG. 1, the kit-of-parts 1 further comprises a base 6, wherein the thick skirt cutting tool 4 and the diaphragm cutting tool 5 are moveably arrangeable relative to said base 6 and relative to each other. The base 6 is arrangeable to an articulated arm with a robot head. Thus, the kit-of-parts 1 may be part of a robot 27 comprising an articulated arm 28 with a robot head 29 carrying the base 6 with an assembly of the thick skirt cutting tool 4 and the diaphragm cutting tool 5 (FIG. 13).

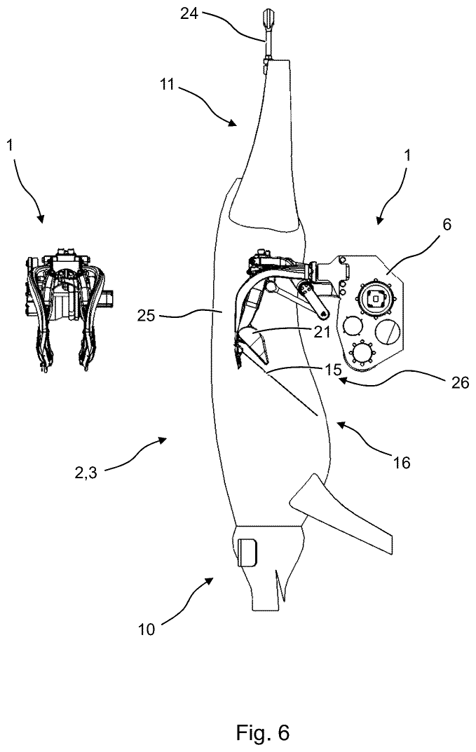

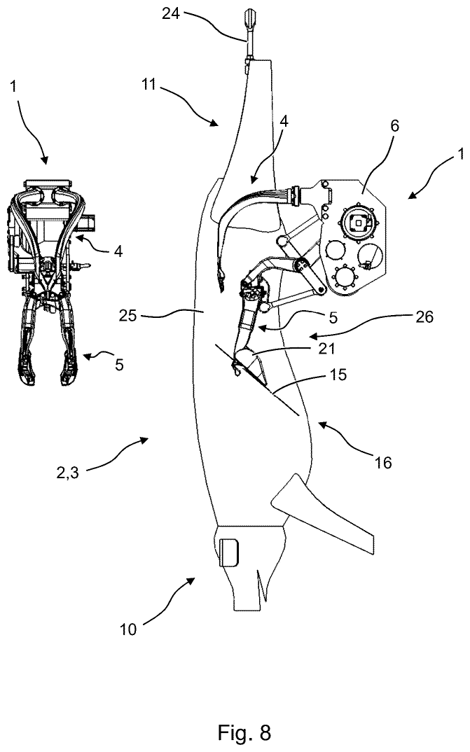

The thick skirt cutting tool 4 is shown in greater detail in FIG. 2. It comprises two arms 7 that are moveable relative to each other between a piercing entry state thereof (FIG. 6) and a thick skirt cutting state (FIG. 8). At least one arm 7, and preferably each arm 7, comprises a thick skirt cutting blade 8 that is arranged at an inner side 9 of said arm 7 that faces the other arm 7 to thereby allow the two arms 7 to enclose an acute angle in the thick skirt cutting state and cut a (not shown) thick skirt of the slaughter animal 2 when the thick skirt cutting tool 4 is moved away from a head portion 10 towards a rear end portion 11 of the slaughter animal 2 (FIG. 8).

The diaphragm cutting tool 5 is shown in greater detail in FIG. 3. It comprises two legs 12 that each comprise a diaphragm cutting blade 13 arranged near an end 14 of said leg 12 and configured to cut the diaphragm 15 along at least a part of the inner contour of the breast cavity 16.

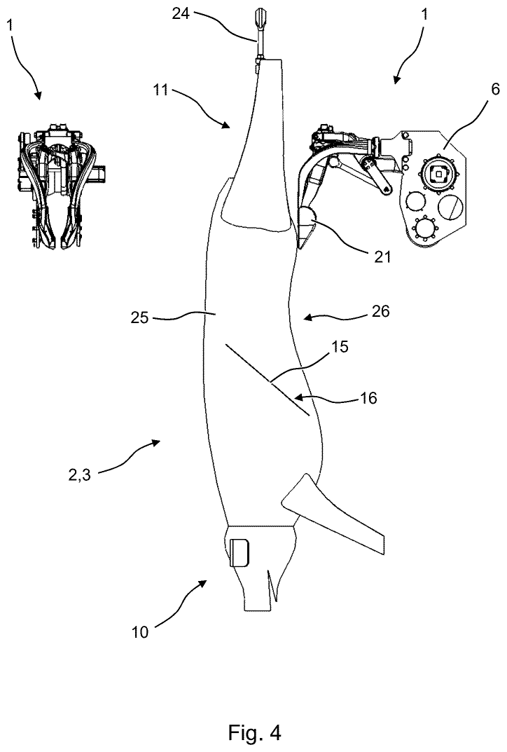

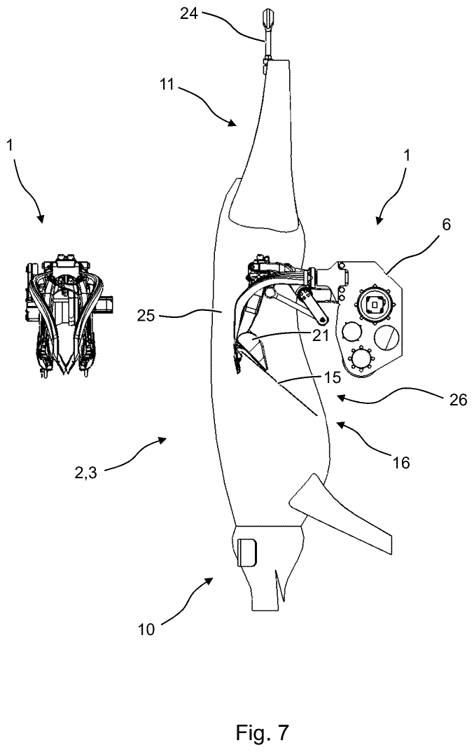

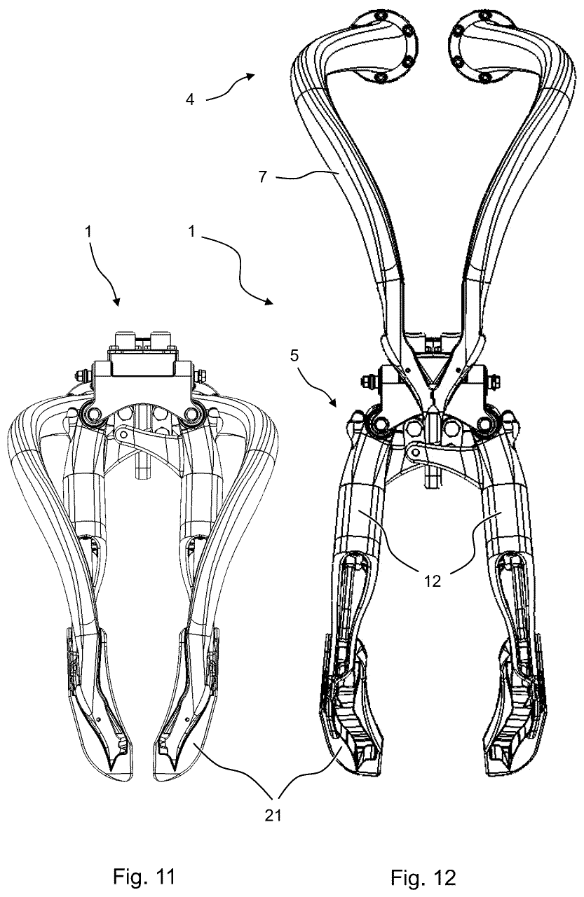

The two legs of the diaphragm cutting tool 5 are moveable relative to each other between an entry state thereof (FIG. 7), wherein the legs 12 are a first offset apart, and a diaphragm cutting state (FIG. 8), wherein the legs 12 are spread apart further relative to the entry state to thereby allow the legs 12 to follow a predetermined contour. It is noted here that the legs 12 being moveable relative to each other encompasses both the situation wherein both legs 12 are moveable relative to a common reference such as the base 6, and the situation wherein one of the legs 12 is fixed relative to a common reference such as the base 6, whereas the other is movable relative to this common reference. Special reference is made to FIGS. 11 and 12, that show the frontal views of the kit-of-parts conform FIGS. 4 and 8, respectively. These larger drawings allow a more detailed comparison to be made between the states of FIGS. 4 and 8, wherein it can be seen that the legs 12 are spread further apart in FIG. 12 (that represents the state shown in FIG. 8), relative to FIG. 11 (that represents the state shown in FIG. 4).

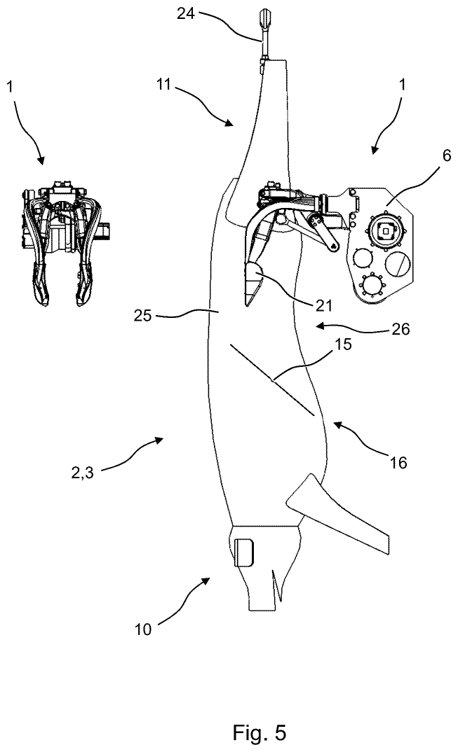

At least one of the thick skirt cutting tool 4 and the diaphragm cutting tool 5 comprises a diaphragm piercer 19 that is configured to pierce a diaphragm 5 of the slaughter animal 2 when said diaphragm piercer 19 is moved from the rear end portion 11 towards the head portion 10 of the slaughter animal 2. This movement corresponds to the movement from the state in FIG. 5 towards the state in FIG. 6, wherein the diaphragm piercer 19 has already pierced the diaphragm 5 in FIG. 6.

In the shown embodiment, the diaphragm piercer 19 is arranged at an end 20 of each arm 7 of the thick skirt cutting tool 4, and the entry state of the thick skirt cutting tool 4 defines a diaphragm piercing state thereof. The diaphragm piercer 19 comprises a pointed cutting blade 23 extending in a longitudinal direction of said arm 7 outward relative to the end 20 of said arm 7.

In the entry state of the thick skirt cutting tool 4, the two arms 7 position the diaphragm piercers 19 at a first distance in the range of 25-150 mm, preferably in the range of 50-100 mm, and more preferably in the range of 60-80 mm, to thereby position the diaphragm piercers 19 on opposite sides relative to a sagittal plane of the slaughter animal 2.

In the thick skirt cutting state of the thick skirt cutting tool 4 shown in the Figures, the arms 7 are substantially closed to thereby define a V-shape by the thick skirt cutting blades 8 of the two arms 7. Preferably, the arms 7 are fully closed, i.e. both arms 7 are in abutting contact with each other. However, alternatively, the arms 7 may be arranged at a second distance, that is smaller than the first distance, relative to each other, to thereby define a V-shape by the thick skirt cutting blades 8 of the two arms. If the arms 7 are closed, this second distance reaches a value of 0 mm.

In the entry state of the diaphragm cutting tool 5, the first offset is in the range of 25-150 mm, preferably in the range of 50-100 mm, and more preferably in the range of 60-80 mm.

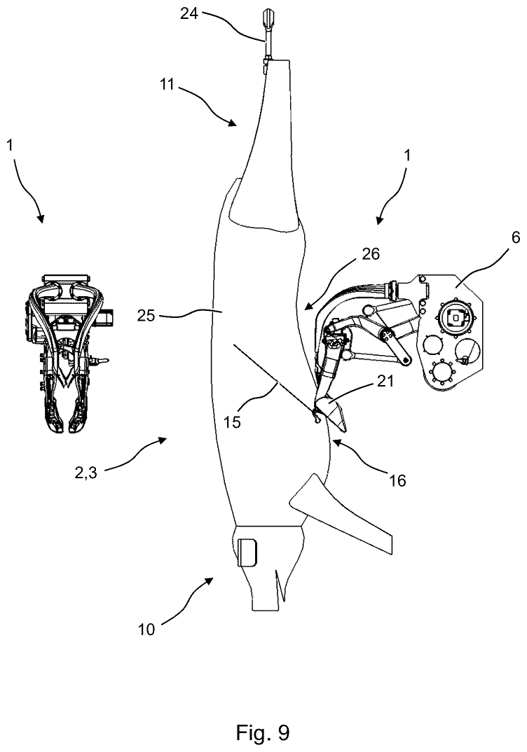

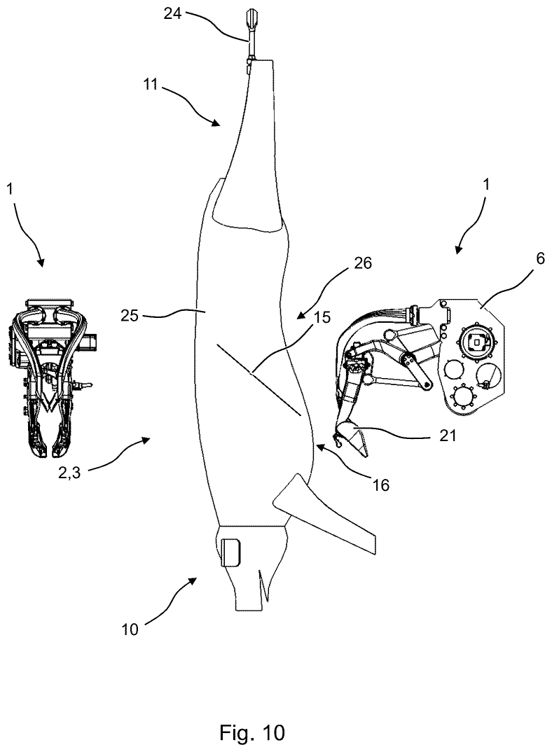

The kit-of-parts 1 further comprises one or more than one cover 21 that is configured to selectively cover one or more than one of the diaphragm piercers 19 of the thick skirt cutting tool 4, the thick skirt cutting blades 8 of the thick skirt cutting tool 4, and the diaphragm cutting blades 13 of the diaphragm cutting tool 5. The one or more than one cover 21 is pivotable between a shielding state and an exposing state, wherein:
in the shielding state (shown in FIGS. 3, 4, and 5), the one or more than one cover 21 shields at least one of the diaphragm piercers 19 of the thick skirt cutting tool 4, the thick skirt cutting blades 8 of the thick skirt cutting tool 4 and the diaphragm cutting blades 13 of the diaphragm cutting tool 5 off to protect the intestines and/or other parts of the digestive system in an abdominal cavity of the slaughter animal 2; and
in the exposing state (shown in FIG. 6-10), the cover 21 is pivoted away from the diaphragm piercers 19 of the thick skirt cutting tool 4 and the diaphragm cutting blades 13 of the diaphragm cutting tool 5 to thereby expose them for piercing and cutting.

Said one or more than one cover 21 preferably comprises at least two covers 21, wherein each cover 21 is arranged at one of both arms 7 of the thick skirt cutting tool 4 and/or at one of both legs 12 of the diaphragm cutting tool 5. The latter is the case in the preferred embodiment shown in the Figures.

As can be best seen in FIG. 3, the one or more than one cover 21 preferably comprises an outer shape that is configured to automatically urge the cover 21 from the shielding state to the exposing state when said cover abuts and slides against the diaphragm 5 of the slaughter animal 2. This is shown in FIG. 6.

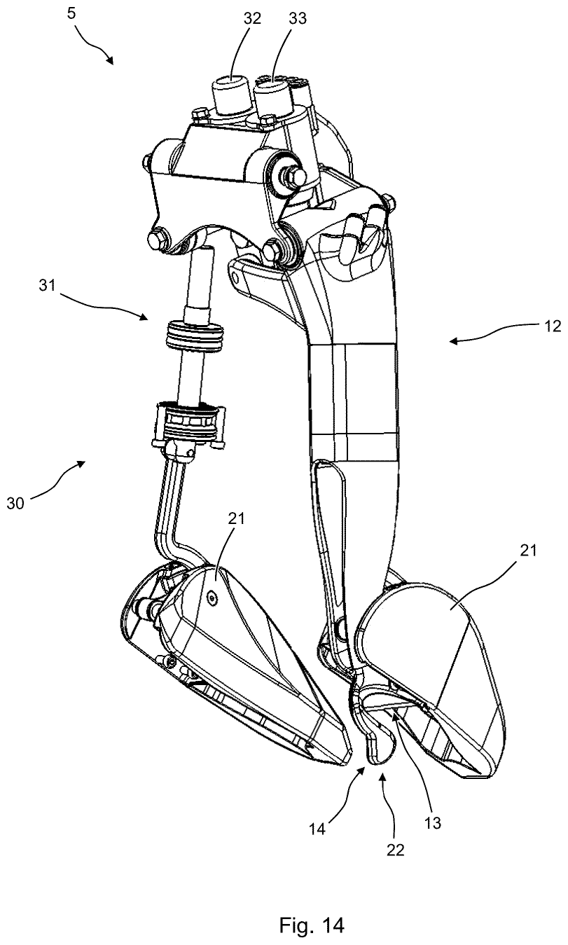

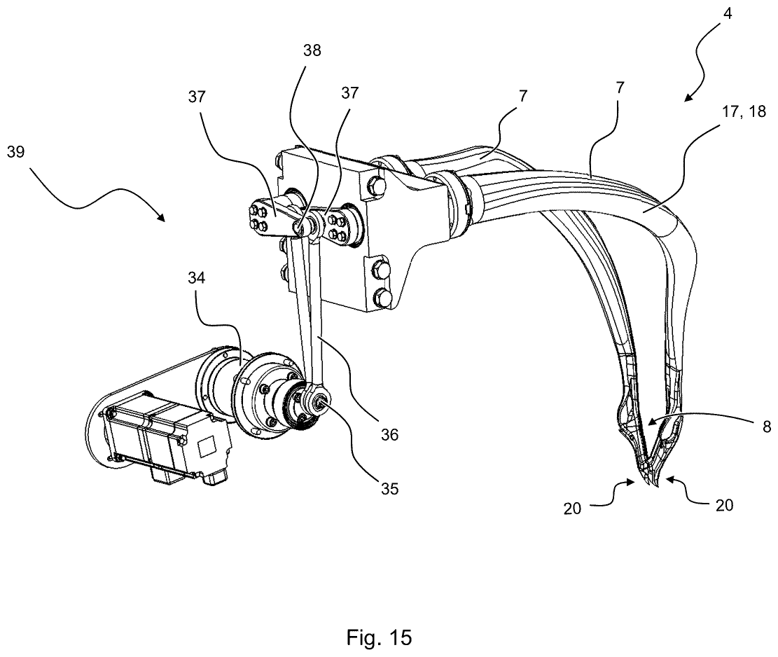

The kit-of-parts may also further comprise an actuator 30 configured to actively pivot the one or more than one cover 21 between the shielding state and the exposing state. FIG. 14 shows the diaphragm cutting tool of FIG. 3, wherein the mechanism inside the left leg 12 is shown. The actuator 30 preferably is an actuatable cylinder 31, more preferably a pneumatic cylinder. An input connector 32 and an output connector 33 for a pneumatic source allow the actuator 30 to be actively extended and retracted.

In the shown embodiment of FIG. 1, the arms 7 of the thick skirt cutting tool 4 and the legs 12 of the diaphragm cutting tool 5 are moveable in parallel or coinciding planes.

Preferably, and as shown in FIG. 3, the thick skirt cutting blades 8 of the thick skirt cutting tool 4 extend substantially transverse to the diaphragm cutting blades 13 of the diaphragm cutting tool 5. More in particular, the diaphragm cutting blades 13 are substantially directed in an imaginary plane that is parallel to or coinciding with a longitudinal direction of the legs 12. The thick skirt cutting blades 8 are directed transverse thereto, i.e. inward from one arm 7 of the thick skirt cutting tool 4 towards the other arm 7 of the thick skirt cutting tool 4.

As can be best seen in FIG. 2, the arms 7 of the thick skirt cutting tool 4 have a curved design. The shape of the arms 7 allows the thick skirt cutting tool 4 to slide along a spine of the slaughter animal 3, thereby positioning the thick skirt cutting blade 8 of the thick skirt cutting tool 4 behind an aorta of the slaughter animal 2.

An outer side 17 of each arm 7 of the thick skirt cutting tool 4 preferably defines a guide surface 18 configured to guide the pierced diaphragm 5 towards the diaphragm cutting blades 13 of the diaphragm cutting tool 5.

The kit-of-parts 1 further comprises a drive 34 configured to drive the arms 7 of the thick skirt cutting tool 4. This drive 34 is preferably a rotational drive, preferably a positioned controlled rotational drive such as a servo motor. The rotational movement is converted into a longitudinal movement using a drive mechanism 39. Pivot 35 is eccentrically arranged relative to a drive shaft of the drive 34. Due to this eccentric drive mechanism, when the rotational drive 34 rotates its drive shaft, pivot 35 rotates around the rotational axis of the drive shaft of drive 34, thereby causing the rod 36 to make a linear reciprocating motion. This linear reciprocating motion of rod 36 causes a rotational reciprocating motion of radial extensions 37 of the arms 7, to which the rod 36 is pivotably connected via a further pivot 38.

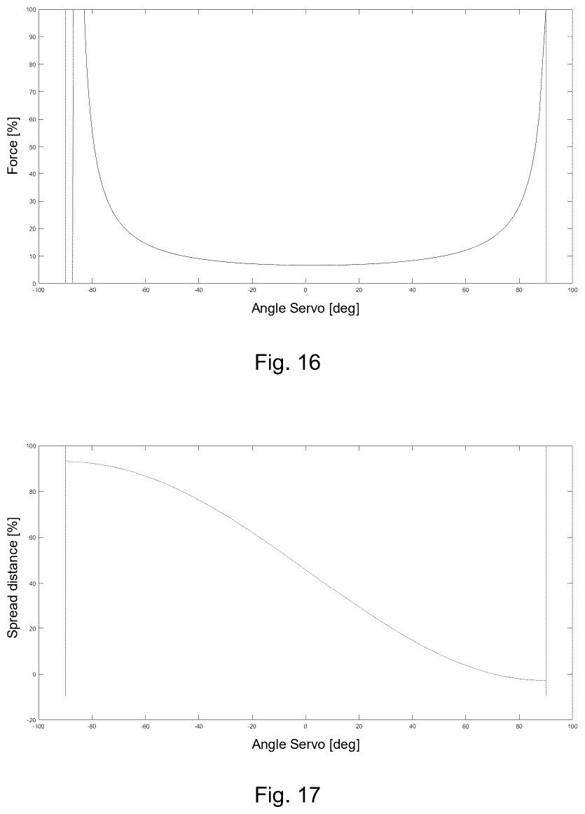

Drive mechanism 39 not only allows a rotational drive 34, that is preferably embodied as a servo motor, to convert the rotational movement of the drive 34 into a reciprocating rotational movement of the arms 7, but also achieves a further technical effect. After all, the circular path of the rotating pivot 35 results in a sinusoidal movement, and consequently the arms 7 of the thick skirt cutting tool 4 are displaced relatively fast towards and away from each other when the ends 20 of said arms 7 are still relatively far away from each other, while this displacement slows down when the ends 20 of the arms 7, and consequently also the thick skirt cutting blades 8, are closer towards each other. Thus, although the rotational drive 34 may rotate at a constant speed, the speed of movement of the arms 7 is automatically controlled via the drive mechanism 39. More in particular, as the speed of movement of the arms 7 slows down, this means that a specific angular displacement of the drive shaft of drive 34 results in less displacement of the ends 20 of the arms. As a result, the force at the end of the arms 20 increases, thereby providing additional force for cutting the thick skirt of the slaughter animal 2 with the thick skirt cutting blades 8. A comparison between FIGS. 16 and 17 shows this effect in a diagram. Both FIGS. 16 and 17 show an angular setting (in degrees) of the drive 34, that is preferably embodied as a servo motor. In FIG. 16, the associated force at the ends 20 of the arms 7 of the thick skirt cutting tool 4, i.e. where the diaphragm piercers 19 are situated, is plotted. FIG. 17 shows a spread distance between the ends 10 of the arms 7 of the thick skirt cutting tool 4 versus an associated angle of the drive 34. As shown in these FIGS. 16 and 17 on the right side of the diagram, an angle of 90° of the drive 34 is associated with a minimum spread distance between the ends 10 of the arms 7 of the thick skirt cutting tool 4, whereas the force diagram shows a maximum force at this angle of 90°. The drive mechanism 39 thus results in a force optimalization for cutting the thick skirt of the slaughter animal 2 with the thick skirt cutting blades 8. Each leg 12 of the diaphragm cutting tool 5 may further comprise a guide 22 configured to guide the diaphragm to the diaphragm cutting blade 13 and the lungs away from the diaphragm cutting blade 13 of the slaughter animal 2.

The kit-of-parts 1 preferably comprises a (not shown) further drive that is configured to drive the legs 12 of the diaphragm cutting tool 5. The further drive is preferably a force controlled drive, such as a cylinder, more preferably a pneumatic cylinder. Alternatively, the further drive may be positioned controlled, or comprise a resilient member.

With reference to the successive method steps shown in FIGS. 4-10, the method of eviscerating a quadruped slaughter animal 2, in particular a pig 3, is now explained in more detail. Each of these FIGS. 4-10 show a side view of a pig 3 and a kit-of-parts 1 performing an eviscerating action. On the left side of these Figures, the kit-of-parts is also shown in a frontal view, showing the positioning of the arms 7 of the thick skirt cutting tool 4 and the legs 12 of the diaphragm cutting tool 5 in the corresponding step.

In FIG. 4, the kit-of-parts 1 is arranged on a base 6. This base 6 is arrangeable on a robot head 29 at an articulated arm 28 of a robot 27, as shown in FIG. 11. Movement of the kit-of-parts 1 throughout the successive Figures is executed by this (not shown) robot. The pig 3 is hanging with its head 10 downwards, suspended from a hook 24 of a (not shown) overhead transporter. The carcass 25 is opened on the abdominal side 26 in a previous step in the slaughtering process.

In FIG. 5, the kit-of-parts 1 has been introduced into the abdominal space of the slaughter animal 2. The arms 7 of the thick skirt cutting tool 4 and the legs 12 of the diaphragm cutting tool 5 may be moved towards each other to temporarily reduce the size of the kit-of-parts 1 and allow it to be introduced into the abdominal space more easily. As can be seen in FIG. 5, the arms 7 of the thick skirt cutting tool 4 and the legs 12 of the diaphragm cutting tool 5 are spread relative to the situation shown in FIG. 4 after introduction of the kit-of-parts 1 in the abdominal space.

The next steps comprise moving the kit-of-parts 1 from the rear end portion 11 towards the head portion 10 of the slaughter animal 2. The kit-of-parts 1 thereby simultaneously moves the thick skirt cutting tool 4 and the diaphragm cutting tool 5 towards the head portion 10, i.e. downwards in the Figures. From FIG. 5 to FIG. 6, the kit-of-parts has been moved downwards towards the head portion 10, thereby piercing the diaphragm 15 of the slaughter animal 2. The step of piercing the diaphragm 15 of the slaughter animal 2 is preferably performed by a diaphragm piercer 19 of the thick skirt cutting tool 4. In the shown embodiment, the diaphragm piercers 19 comprise a pointed cutting blades 23 extending in a longitudinal direction of the arms 7 outward relative to the ends 20 of the arms 7 of the thick skirt cutting tool 4. During the step of piercing the diaphragm 15 of the slaughter animal 2, the diaphragm piercer 19 of the thick skirt cutting tool 4 of the shown embodiment extends beyond an end of the diaphragm cutting tool 5.

As can also be seen in FIG. 6, also the covers 21 have been opened to expose the diaphragm piercers 19 of the thick skirt cutting tool 4 and/or the diaphragm cutting blades 13 of the diaphragm cutting tool 5. The one or more than one cover 21 preferably comprises an outer shape that is configured to automatically urge the cover 21 from the shielding state to the exposing state when said cover abuts and slides against the diaphragm 5 of the slaughter animal 2. Alternatively, or additionally, the covers 21 may be actuatable with a (not shown) actuator.

In FIG. 7, the arms 7 of the thick skirt cutting tool 4 have been moved towards each other, thereby bringing the one or more than one thick skirt cutting blade 8 arranged at an inner side 9 of a respective arm 7 in contact with the thick skirt of the slaughter animal 2. The two arms 7 enclose an acute angle in the thick skirt cutting state to cut the thick skirt of the slaughter animal 2 when the thick skirt cutting tool 4 is moved away from a head portion 10 towards a rear end portion 11 of the slaughter animal 2, i.e. upward in the embodiment shown in the Figures.

In FIG. 8, the thick skirt cutting tool 4 has been moved towards the rear end portion 11 of the slaughter animal 2, i.e. upward, along the spine of the slaughter animal 2, to cut the thick skirt. The thick skirt cutting tool 4 thus comprises two arms 7 that are moveable relative to each other, wherein:
said arms 7 are spaced apart during the step of moving the thick skirt cutting tool 4 from the rear end portion 11 towards the head portion 10 of the slaughter animal 2 (i.e. from FIG. 5 to FIG. 6); and
said arms 7 are substantially closed, thereby defining a V-shape with thick skirt cutting blades 8 that are arranged at the two arms 7 (FIG. 7), during the step of moving the thick skirt cutting tool 4 backwards towards the rear end portion 11 and thereby cutting the thick skirt of the slaughter animal 2 (i.e. from FIG. 7 to FIG. 8).

The shape of the thick skirt cutting tool 4 may help to push the kidneys of the slaughter animal 2 out of the abdominal space.

Referring to FIG. 8, the diaphragm cutting tool 5 has already slightly moved further towards the head portion 10 of the slaughter animal 2, thereby moving outward of the breast cavity 16 along the along the diaphragm 15 and cutting the diaphragm 15 along an inner contour of the breast cavity 16 of the slaughter animal 2. The diaphragm cutting tool 5 thus makes a diagonal downward movement relative to the longitudinal direction of the slaughter animal 2, wherein this diagonal movement at least has a direction component in the downward direction, i.e. towards the head portion 10.

Because the kit-of-parts 1 according to the invention is capable of piercing the diaphragm 15, and then successively removing the thick skirt with the thick skirt cutting tool 4 during a rear end portion 11 directed movement, i.e. an upward movement in the Figures, and cutting the diaphragm with the diaphragm cutting tool 5 during a head 10 directed (and outward) movement, i.e. a downward (and outward) movement in the Figures, the method is capable of performing the step of simultaneously removing white and red organs from the slaughter animal.

The above-described embodiment is intended only to illustrate the invention and not to limit in any way the scope of the invention. Accordingly, it should be understood that where features mentioned in the appended claims are followed by reference signs, such signs are included solely for the purpose of enhancing the intelligibility of the claims and are in no way limiting on the scope of the claims. The scope of protection is defined solely by the following claims.

1.-29. (canceled)

30. A kit-of-parts configured to eviscerate a quadruped slaughter animal, in particular a pig, comprising:
a thick skirt cutting tool, comprising two arms that are moveable relative to each other between a piercing entry state thereof and a thick skirt cutting state, wherein at least one arm, and each arm, comprises:
a thick skirt cutting blade arranged at an inner side of said arm that faces the other arm to thereby allow the two arms to enclose an acute angle in the thick skirt cutting state and cut a thick skirt of the slaughter animal when the thick skirt cutting tool is moved away from a head portion towards a rear end portion of the slaughter animal; and
a diaphragm cutting tool, comprising two legs that each comprise a diaphragm cutting blade arranged near an end of said leg and configured to cut the diaphragm along at least a part of an inner contour of the breast cavity.

31. The kit-of-parts according to claim 30, wherein the two legs of the diaphragm cutting tool are moveable relative to each other between an entry state thereof, wherein the legs are a first offset apart, and a diaphragm cutting state,
wherein the legs are spread apart further relative to the entry state to thereby allow the legs to follow a predetermined contour.

32. The kit-of-parts according to claim 30, wherein at least one of the thick skirt cutting tool and the diaphragm cutting tool comprises a diaphragm piercer that is configured to pierce a diaphragm of the slaughter animal when said diaphragm piercer is moved from a rear end portion towards a head portion of the slaughter animal.

33. The kit-of-parts according to claim 32, wherein the diaphragm piercer is arranged at an end of an arm, and each arm, of the thick skirt cutting tool, and the entry state of the thick skirt cutting tool defines a diaphragm piercing state thereof.

34. The kit-of-parts according to claim 30, further comprising one or more than one cover configured to selectively cover one or more than one of:
the diaphragm piercers of the thick skirt cutting tool;
the thick skirt cutting blades of the thick skirt cutting tool, and
the diaphragm cutting blades of the diaphragm cutting tool.

35. The kit-of-parts according to claim 34, wherein the one or more than one cover is pivotable between a shielding state and an exposing state, wherein:
in the shielding state, the one or more than one cover shields at least one of the diaphragm piercers of the thick skirt cutting tool, the thick skirt cutting blades of the thick skirt cutting tool, and the diaphragm cutting blades of the diaphragm cutting tool off to protect the intestines and/or other parts of the digestive system in an abdominal cavity of the slaughter animal; and
in the exposing state, the cover is pivoted away from at least one of the diaphragm piercers of the thick skirt cutting tool, the thick skirt cutting blades of the thick skirt cutting tool, and the diaphragm cutting blades of the diaphragm cutting tool to thereby expose them for piercing and cutting.

36. The kit-of-parts according to claim 34, wherein said one or more than one cover comprises at least two covers, wherein each cover is arranged at:
one of both arms of the thick skirt cutting tool; and/or
one of both legs of the diaphragm cutting tool.

37. The kit-of-parts according to claim 35, wherein said one or more than one cover comprises an outer shape that is configured to automatically urge the cover from the shielding state to the exposing state when said cover abuts and slides against the diaphragm of the slaughter animal.

38. The kit-of-parts according to claim 30, comprising a drive configured to drive the arms of the thick skirt cutting tool.

39. The kit-of-parts according to claim 30, wherein each leg of the diaphragm cutting tool further comprises a guide configured to guide the lungs of the slaughter animal.

40. The kit-of-parts according to claim 30, comprising a base, wherein the thick skirt cutting tool and the diaphragm cutting tool are moveably arrangeable relative to said base and relative to each other.

41. The kit-of-parts according to claim 40, wherein the arms of the thick skirt cutting tool and the legs of the diaphragm cutting tool are moveable in parallel or coinciding planes.

42. A robot, comprising an articulated arm with a robot head carrying the base according to claim 40 with the assembly of the thick skirt cutting tool and the diaphragm cutting tool.

43. A method of eviscerating a quadruped slaughter animal, in particular a pig, comprising the steps of:
simultaneously moving a thick skirt cutting tool and a diaphragm cutting tool from a rear end portion towards a head portion of the slaughter animal;
piercing the diaphragm of the slaughter animal;
moving the thick skirt cutting tool backwards towards the rear end portion and thereby cutting the thick skirt of the slaughter animal; and
moving the diaphragm cutting tool further towards the head portion of the slaughter animal and thereby cutting the diaphragm along an inner contour of a breast cavity of the slaughter animal.

44. The method according to claim 43, wherein the step of piercing the diaphragm of the slaughter animal is performed by a diaphragm piercer of the thick skirt cutting tool.

45. The method according to claim 44, wherein during said step of piercing the diaphragm of the slaughter animal, the diaphragm piercer of the thick skirt cutting tool extends beyond an end of the diaphragm cutting tool.

46. The method according to claim 43, wherein the thick skirt cutting tool comprises two arms that are moveable relative to each other, wherein:
said arms are spaced apart during the step of moving the thick skirt cutting tool from the rear end portion towards the head portion of the slaughter animal; and
said arms are substantially closed, thereby defining a V-shape with thick skirt cutting blades that are arranged at the two arms, during the step of moving the thick skirt cutting tool backwards towards the rear end portion and thereby cutting the thick skirt of the slaughter animal.

47. The method according to claim 43, further comprising the step of simultaneously removing white and red organs from the slaughter animal.

48. The method according to claim 43, further comprising the step of using a thick skirt cutting tool according to a kit-of-parts comprising:
a thick skirt cutting tool, comprising two arms that are moveable relative to each other between a piercing entry state thereof and a thick skirt cutting state, wherein at least one arm, and each arm, comprises:
a thick skirt cutting blade arranged at an inner side of said arm that faces the other arm to thereby allow the two arms to enclose an acute angle in the thick skirt cutting state and cut a thick skirt of the slaughter animal when the thick skirt cutting tool is moved away from a head portion towards a rear end portion of the slaughter animal; and
a diaphragm cutting tool, comprising two legs that each comprise a diaphragm cutting blade arranged near an end of said leg and configured to cut the diaphragm along at least a part of an inner contour of the breast cavity.

49. The method according to claim 43, further comprising the step of using a diaphragm cutting tool according to a kit-of-parts comprising:
a thick skirt cutting tool, comprising two arms that are moveable relative to each other between a piercing entry state thereof and a thick skirt cutting state, wherein at least one arm, and each arm, comprises:
a thick skirt cutting blade arranged at an inner side of said arm that faces the other arm to thereby allow the two arms to enclose an acute angle in the thick skirt cutting state and cut a thick skirt of the slaughter animal when the thick skirt cutting tool is moved away from a head portion towards a rear end portion of the slaughter animal; and
a diaphragm cutting tool, comprising two legs that each comprise a diaphragm cutting blade arranged near an end of said leg and configured to cut the diaphragm along at least a part of an inner contour of the breast cavity.
